(19) United States
(12) Patent Application Publication
(10) Pub. No.: US 2021/0234850 A1
(43) Pub. Date: Jul. 29, 2021

(54) SYSTEM AND METHOD FOR ACCESSING ENCRYPTED DATA REMOTELY

(71) Applicant: Logonsafe LLC, Chelsea, MI (US)

(72) Inventor: Sean Vogt, Chelsea, MI (US)

(73) Assignee: Logonsafe LLC, Chelsea, MI (US)

(21) Appl. No.: 16/750,057

(22) Filed: Jan. 23, 2020

(51) Int. Cl. H04L 29/06; H04W 12/06; H04L 29/08

(52) U.S. Cl. CPC H04L 63/083; H04W 12/06; H04L 67/26; H04L 63/10; H04L 63/0853; H04L 63/0815

(57) ABSTRACT

A process and system of enhancing the security of authentication mechanism that includes registering an authorized device having memory storage on an authentication platform; storing login credentials for at least one account in the memory of the authorized device; receiving on the authentication platform a request for login credentials from a secondary device; transmitting the request for credentials from the authentication platform to the authorized device; prompting a user to respond to the request to authorize transmission of the confidential data between the secondary device and the service provider; and transmitting the requested credentials from the memory on the authorized device to the secondary device when the user provides authorization via the authorized device.

### FIELD OF THE DISCLOSURE

This disclosure relates to digital security, and more specifically, to systems and methods for improving the security of authentication mechanisms, and the storage of encrypted authentication credentials.

### BACKGROUND OF THE DISCLOSURE

Businesses and individuals are increasingly reliant on the ability to transact business, access accounts, and store and retrieve confidential information via the internet. This has unfortunately attracted cybercriminals that attempt and often successfully gain access to accounts and other sensitive information, robbing businesses and individuals, and/or selling credentials or other confidential information to other criminals.

Such confidential transactions have often been, and still are, protected by nothing more than a user name and password. Username/password protection can be effective when non-trivial, difficult-to-guess usernames and passwords are used, frequently changed, and unique for each user account. However, in practice, people prefer usernames and passwords that are easy for them to remember, often using the identical or very similar usernames and passwords on various different accounts, and rarely, if ever changing usernames and/or passwords. With current technology, these problems can be overcome with a username/password manager that can generate, store and manage login credentials for a user's devices, making it easy to develop strong, unique passwords for each account without needing to commit these passwords to memory (e.g., the user only needs to remember a single master password that protects all the other passwords). An obvious disadvantage with a password (or credential) manager is that it can provide a cyber-criminal full access to all of the user's accounts if the device on which the password manager resides is infected with many strains of modern malware that include keyloggers and remote access to the file system of the infected device.

With a keylogger, an attacker can record the decryption key (often called a “Master Password”), and with remote access to the file system they can also access the encrypted data that is protected by the Master Password. Decrypting the victim's credentials then becomes trivial for the attacker, and all services stored in the password manager become compromised at the same time, including services they may not have had access to without the use of the password manager.

Two-factor authentication adds an extra layer of security, such as by requiring that the user provide an answer to a question that only the user is likely to know (e.g., name of first pet, make and model of first automobile, etc.). Other two-factor authentication schemes involve the use of a hardware token (e.g., a key fob that displays a new numeric code every 30 seconds), SMS-based authentication that sends a unique one-time passcode via text message to the user's cellular telephone, and push notification authentication to an authenticated device (typically the user's cellular telephone) which can be accepted or declined. A known disadvantage with these two-factor authentication systems is that they only work with accounts that integrate these types of authentication processes and/or equipment into their services. Also, users can find some of these two-factor schemes burdensome, as they require the user to either remember the requested information (e.g., answers to personal questions) or carry extra devices (e.g., hardware tokens).

### SUMMARY OF THE INVENTION

Disclosed is a process and system for authentication that decouples the storage and decryption of the authentication credentials from the device that requires authentication. This provides enhanced security to the user, and provides verifiable proof that it is in fact the user that is using the credentials to authenticate rather than an attacker using previously compromised credentials. The methods and systems involve registering an authorized device having memory storage on an authentication platform; storing authentication credentials for at least one account in the memory of the authorized device; receiving on the authentication platform a request for login credentials from a secondary device; transmitting the request for credentials from the authentication platform to the authorized device; prompting a user to respond to the request to authorize transmission of the confidential data between the secondary device and the service provider; and facilitating communication of the requested credentials from the memory on the authorized device to the secondary device.

### BRIEF DESCRIPTION OF THE DRAWINGS

FIG. 1 is a schematic illustration of a method and system in accordance with the disclosure for establishing a connection between the “secondary device” that is authenticating to a service, and the “Authorized Device” which is responsible for storing and decrypting the authentication credentials of a user's internet-based account(s).

FIG. 2 is an alternative or supplemental protocol for communicating credentials from an authenticated device to a secondary device.

### DETAILED DESCRIPTION

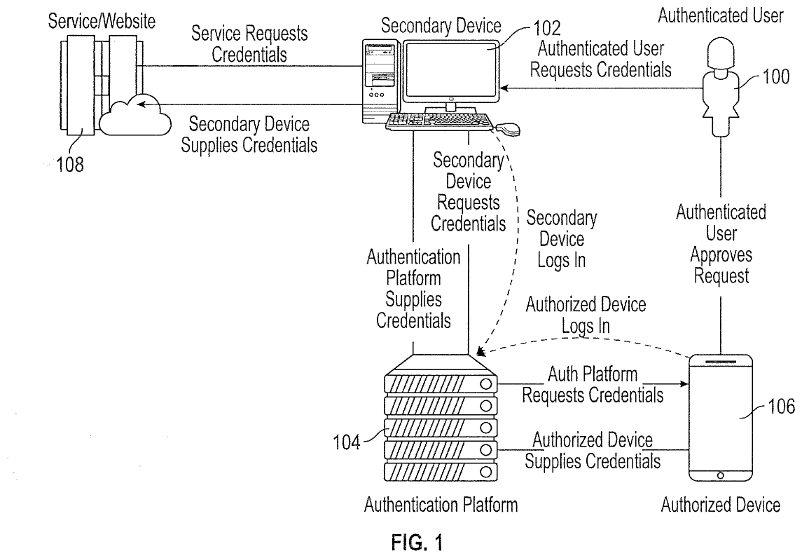

The methods and apparatus or systems of this disclosure provide a user with an additional layer of authentication for the user's accounts regardless of, and in addition to, any security measures provided by a service provider or account manager. A process and system in accordance with this disclosure is schematically illustrated in FIG. 1.

The process can be initiated by an authenticated user who may access the authentication platform 104 via a secondary device 102. The secondary device can be generally any computing device having access to a network (including the internet), via wired or wireless connection, but is most typically a personal computer or tablet computer. After (or before) the authenticated user has successfully logged into the authentication platform, such as by entering a username and associated password on record with the authentication platform, the user may request credentials (e.g., username and password) for a website or service for which the authenticated user has an account. The account or service that the authenticated user wishes to access can be entered via the login screen or other input interface maintained by the authentication platform, such as by keying in the URL for the website on which the account is maintained. Alternatively, a web-based application can be downloaded from the authentication platform to the secondary device and can include a software module for recognizing the login webpage associated with an account. In a preferred embodiment, the accounts and account URLs can be maintained in the memory of the authentication platform.

In a further step, the authentication platform requests the appropriate credentials for the account that the authenticated user wishes to access from an authorized device 106. The credentials for a plurality of accounts maintained by different service providers and/or websites can be managed by a downloadable mobile app operating on the authorized device. The mobile app can be downloaded to the authorized device (e.g., from the authentication platform) during an initial set-up, during which the authenticated user can enter account URLs and the associated usernames and passwords. Either the mobile app or the application on the secondary device (or both) could include options to prompt the user to routinely update or change passwords and/or usernames. The mobile app and/or application on the secondary device could also include an option to autogenerate suggested new passwords and/or usernames. These features can allow a very high level of security (i.e., strong passwords and usernames that are regularly changed and are all different), without requiring the authenticated user to memorize any credentials other than those needed to logon to the authentication platform.

Before the credentials requested by the authentication platform are supplied by the authorized device, the mobile app can display a screen on the authorized device that requests that the user choose to either allow or deny the request for credentials. This prevents an unauthorized user that has managed to log onto the authentication platform with the authenticated user's credentials (to access the authentication platform) from logging into the authenticated user's accounts, unless the unauthorized user also has possession of and access to the authorized device. The authorized device is most typically a smartphone or other mobile computing device that is normally and exclusively in the possession of the authenticated user.

The authentication platform would typically be a server maintained by a security services provider but could be any device running the server software. In certain aspects of this disclosure, the user(s) can register multiple authorized devices.

In the event that an unauthorized user successfully logs onto the authentication platform, the authenticated user would normally deny the request for credentials. Once this occurs, the authentication platform and/or mobile app operating on the authorized device could require elevated security measures, such as requiring that the authenticated user change the credentials for accessing the authentication platform. The authentication platform can also communicate the compromised credentials to the user's security team, ensuring that the remote account that is compromised is dealt with accordingly (reset passwords, dispute charges, etc.).

Communications between the authentication platform and the authorized device can be via a notification service including push notifications, SMS, audio or visual communication (QR Codes or phone calls), or any other mechanism of communicating between two devices. Therefore, the user may be required to log onto the authentication platform via the authorized device.

The usernames and passwords stored on the authorized device can be encrypted. Desirably, credentials communicated from the authorized device to the authentication platform and from the authentication platform to the secondary device are encrypted.

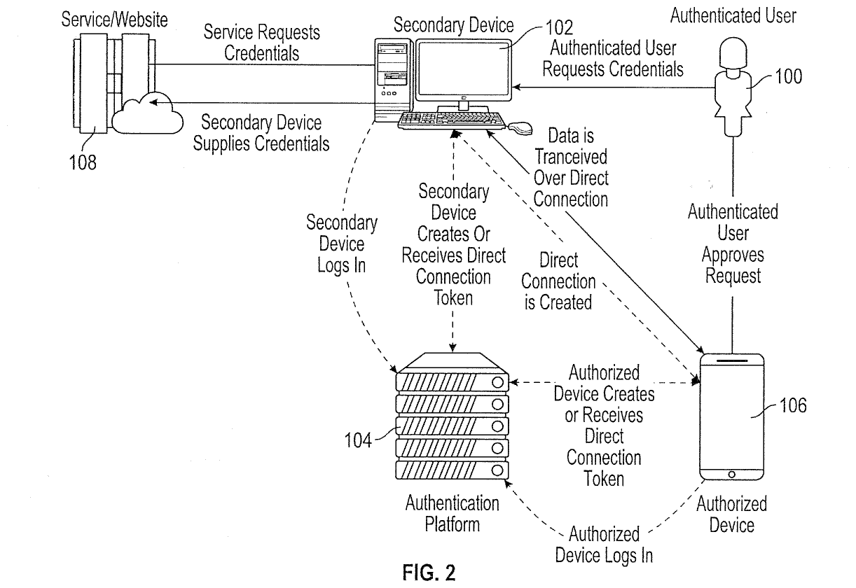

FIG. 2 illustrates a modified process in which the secondary device 102 and the authorized device 106 are directly connected (e.g., a local area network). The authenticated user 100 initiates a request for credentials via the secondary device 102 by authenticating to the authentication platform. The secondary device creates or receives from the authentication platform a direct connection token. A notification is sent from the authentication platform to the authorized device 106 and the authorized device connects to the authentication platform. Thereafter, the authorized device creates or receives a direct connection token from the authentication platform, facilitating direct connection between the authorized device and the secondary device and transmission of credentials directly from the authorized device to the secondary device.

By maintaining credentials only on a separate computing device (e.g., smartphone) that the authenticated user generally and normally maintains in the user's exclusive possession, the need for extra devices is eliminated, while ensuring that access to both the encrypted data and the decryption key is isolated to a secure device.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

What is claimed is:

1. A method of authorizing transmission of confidential data between a secondary device and a service provider, comprising:
registering an authorized device having memory storage on an authentication platform;
storing authentication credentials for at least one account in the memory of the authorized device;
receiving on the authentication platform a request for login credentials from a secondary device;
transmitting the request for credentials from the authentication platform to the authorized device;
prompting a user to respond via the authorized device to the request to authorize transmission of the credentials between the secondary device and the service provider; and
transmitting the requested credentials from the authorized device to the secondary device when authorization is provided by the user via a user interface on the authorized device.

2. The method of claim 1, wherein the authentication credentials comprise one or more unique identifiers.

3. The method of claim 1, wherein the request for credentials from the authentication platform to the authorized device is communicated via a push notification service.

4. The method of claim 1, wherein the request for credentials from the device is initiated by an application executed on the secondary device.

5. The method of claim 1, wherein the development, editing and management of the authentication credentials stored on the memory of the authorized device is performed by a software application operating on the authorized device.

6. The method of claim 1, wherein the authentication platform is a network accessible server.

7. The method of claim 1, wherein the authorized device is a portable device capable of communicating with the authentication platform and/or the secondary device.

8. The method of claim 1, wherein the account is a service or website that requires authentication for access or elevated permissions.

9. The method of claim 1, wherein transmissions of the requested credentials from the authorized device to the authentication platform and from the authentication platform to the secondary device are encrypted.

10. A method of authorizing transmission of confidential data between a secondary device and a service provider, comprising:
registering an authorized device having memory storage on an authentication platform;
storing login credentials for at least one account in the memory of the authorized device;
receiving on the authentication platform a request for login credentials from a secondary device;
transmitting the request for credentials from the authentication platform to the authorized device;
prompting a user to respond to the request to authorize transmission of the confidential data between the secondary device and the service provider; and
transmitting the requested credentials from the memory on the authorized device to the secondary device when authorization is provided by the user via a user interface on the authorized device.

11. The method of claim 10, wherein communication of the requested credentials is facilitated by creating a direct connection token on the secondary device or receiving a direct connection token on the secondary device from the authentication platform, creating a direct connection token on the authorized device or receiving a direct connection token on the authorized device from the authentication platform, and establishing a direct connection between the secondary device and the authorized device,

12. The method of claim 10, wherein the login credentials comprise a unique identifier associated with an account.

13. The method of claim 10, wherein the request for credentials from the authentication platform to the authorized device is communicated via a push notification service, SMS, QR Code, audio communication, or direct connection.

14. The method of claim 10, wherein the development, editing and management of the authentication credentials stored on the memory of the authorized device is performed by a software application operating on the authorized device.

15. The method of claim 10, wherein transmissions of the requested credentials from the authorized device to the authentication platform and from the authentication platform to the secondary device are encrypted.
